(19) United States
(12) Patent Application Publication
(10) Pub. No.: US 2009/0256108 A1
(43) Pub. Date: Oct. 15, 2009

(54) CONDITIONING AGENT FOR ETCHING ENAMEL LESIONS

(75) Inventors: Stephan Neffgen, Hamburg (DE); Swen Leander, Hamburg (DE); Dierk Lubbers, Halstenbek (DE)

Correspondence Address: Casimir Jones, S.C., 440 Science Drive, Suite 203, Madison, WI, 53711, US

(73) Assignee: Ernst Muhlbauer GmbH & Co. KG, Norderfriedrichskoog (DE)

(21) Appl. No.: 12/422,058

(22) Filed: Apr. 10, 2009

Related U.S. Application Data
(60) Provisional application No. 61/045,497, filed on Apr. 16, 2008.

(30) Foreign Application Priority Data
Apr. 11, 2008 (EP) 08007195.4

(51) Int. Cl. C09K 13/00

(52) U.S. Cl. 252/79.1

(57) ABSTRACT

The invention relates to a composition which comprises
a) 4 to 80% by weight of at least one acid which has a pKa of 2 or less;
b) a protic solvent;
   the acid having a saturation vapor pressure at 20° C. of 120 mbar or less, for use as conditioning agent for etching enamel lesions.

The invention relates to a composition for use as conditioning agent for etching enamel lesions, and to a kit for infiltrating enamel lesions.

Caries is a widespread disease of civilization. Every incidence of caries which eventually leads to a cavity starts with demineralization of the dental enamel and, in this stage, is called initial enamel caries. In this stage, the caries is initially invisible or visible only as so-called white enamel lesion, but leads to a porous region of the tooth underneath its surface.

Such an enamel lesion can in principle be remineralized or infiltrated with a synthetic resin (WO 2007/131725 A1). However, a problem with the infiltration with synthetic resin is that a lesion which extends into the dental enamel typically has a so-called pseudointact surface layer on the tooth surface, which layer has a higher mineral content compared with the deeper enamel lesion and impedes or prevents penetration of the enamel lesion with the synthetic resin used for infiltration, called the infiltrant. It has therefore previously been proposed to pretreat these pseudointact surface layers by an etching agent so that, after this conditioning, the infiltrant can penetrate better into the lesion.

The invention is based on the object of providing an effective and readily storable and usable conditioning agent for etching enamel lesions.

The invention thus relates to a composition which comprises:
4 to 80% by weight of at least one acid which has a pKa of 2 or less;
a protic solvent;
the acid having a saturation vapor pressure at 20° C. of 120 mbar or less, for use as conditioning agent for etching enamel lesions.

The acid with a pKa of 2 or less may be an inorganic or organic acid, but mixtures of a plurality of acids are likewise possible. If the acid is polybasic, the first dissociation stage from the state of the acid present in the composition must have a pKa of 2 or less. Preferred upper limits for the pKa are 1.5 and 1.

The protic solvent may be in particular alcohols or water or mixtures thereof. The invention provides for the acid and/or the complete composition to have a saturation vapor pressure at 20° C. of 120 mbar or less. The saturation vapor pressure is the pressure of the gaseous phase of a substance when liquid phase and gaseous phase are in equilibrium.

In the context of the invention, consideration is preferably given to the partial vapor pressure only of the acid in the composition, and the vapor pressure of the solvent can then be ignored.

The invention has recognized that the hydrochloric acid used in the prior art (WO 2007/131725 A1) as conditioning agent has a number of disadvantages. In order to be sufficiently effective as conditioning agent, approximately 15% strength hydrochloric acid must be used. HCl in more concentrated aqueous solutions has a considerable vapor pressure, so that it escapes in the form of a gas from the aqueous hydrochloric acid solution. Corresponding hydrochloric acid solutions thus have low storage stability; in addition, the resistance of the packaging of the conditioning agent is subject to great demands because the HCl escaping in the form of a gas is very aggressive. Furthermore, the HCl escaping in the form of a gas on use may damage biological tissues such as, for example, the gums.

The invention has recognized that the acids, defined in detail in the claim, with a particular minimum acid strength can effectively erode, and thus prepare for the penetration of an infiltrant, the remineralized surface layers of natural enamel lesions. Such pseudointact surface layers of a natural enamel lesion are typically 10 to 40 μm thick and are nevertheless substantially completely penetrated and removed by a composition of the invention in reasonable application times (for example about 90 to 120 s).

The low saturation vapor pressure provided according to the invention ensures that, unlike with the use of hydrochloric acid, aggressive acid constituents do not escape on storage or use of the composition of the invention.

Examples of suitable acids are fluorosulfonic acid, organic sulfonic acids such as, for example, trifluoromethanesulfonic acid, methanesulfonic acid, toluenesulfonic acid, amidosulfonic acid, benzenesulfonic acid, perchloric acid, sulfuric acid, nitric acid, trichloroacetic acid, trifluoroacetic acid, picric acid or semisquaric acid. Preferred acids are methanesulfonic acid and p-toluenesulfonic acid.

Preferred lower limits for the acid content in the conditioning agent are 7% by weight, 10% by weight, 11% by weight, 15% by weight, 20% by weight, 25% by weight, 30% by weight, 40% by weight and 50% by weight. Preferred upper limits are 70 and 60% by weight. Said upper and lower limits can be combined as desired to give ranges according to the invention. Further preferred ranges according to the invention are indicated in dependent claim 2.

Preferred ranges for the pKa of the acids used are −6 to 1, 1.5 or 2, −5 to 1, 1.5 or 2 and −4 to 1, 1.5 or 2. The composition of the invention preferably has a negative pH, with preferred pH values being <−0.1, <−0.5 and <−1.

The selection of acids of sufficiently low volatility takes place according to the invention on the basis of the vapor pressure of the pure acid in a composition of the invention are chosen as criterion which preferably does not exceed 80 mbar, 50 mbar, 20 mbar, 10 mbar or else 5 mbar at 20° C. Alternatively, the vapor pressure of a concentrated acid or of a saturated (preferably aqueous) solution of the corresponding acid can be considered, which pressure preferably does not exceed said limits. It is preferred according to the invention not to employ any hydrohalic acids.

The composition of the invention may additionally comprise thickeners such as, for example, particulate fillers or high-viscosity substances. Suitable thickeners are for example silicas, polyethers or polyols, and polyacrylic acids and copolymers thereof. Further additives such as, for example, colorants or surface-active substances (surfactants) may likewise be present.

The invention further relates to a kit for carrying out an infiltration of dental enamel which includes as constituents a conditioning composition of the invention, and an infiltrant. The infiltrant is preferably a curable (for example light-curable) synthetic resin which, after the preparation of the lesion by the conditioner, can penetrate into this lesion and seal it.

The infiltrant used in this kit preferably has a penetration coefficient of more than 50 cm/s. The penetration coefficient is calculated according to the equation which is detailed hereinafter and can be derived from the so-called Washburn equation:

$$PC = ( \frac{γ \cdot cos θ}{2 η} )$$

PC: penetration coefficient
γ: surface tension of the infiltrant at the air interface
θ: contact angle of the infiltrant at the enamel interface
η: dynamic viscosity of the infiltrant

Further information on determination of the penetration coefficient, including literature references, are to be found in WO 2007/131725 A1, mentioned above, which is incorporated in the present disclosure by reference.

The infiltrant preferably comprises at least one resin selected from the group consisting of MMA, methyl methacrylate; EMA, ethyl methacrylate; n-BMA, n-butyl methacrylate; IBMA, isobutyl methacrylate, t-BMA, tert-butyl methacrylate; EHMA, 2-ethylhexyl methacrylate; LMA, lauryl methacrylate; TDMA, tridecyl methacrylate; SMA, stearyl methacrylate; CHMA, cyclohexyl methacrylate; BZMA, benzyl methacrylate; IBXMA, isobornyl methacrylate; MAA, methacrylic acid; HEMA, 2-hydroxyethyl methacrylate; HPMA, 2-hydroxypropyl methacrylate; DMMA, dimethylaminoethyl methacrylate; DEMA, diethylaminoethyl methacrylate; GMA, glycidyl methacrylate; THFMA, tetrahydrofurfuryl methacrylate; AMA, allyl methacrylate; EGDMA, ethylene glycol dimethacrylate; 3EGDMA, triethylene glycol dimethacrylate; 4EGDMA, tetraethylene glycol dimethacrylate; BDMA, 1,3-butylene glycol dimethacrylate; HDDMA, 1,6-hexanediol dimethacrylate; ETMA, ethoxyethyl methacrylate; 3FM, trifluoroethyl methacrylate; 8FM, octafluoropentyl methacrylate; AIB, isobutyl acrylate; TBA, tert-butyl acrylate; LA, lauryl acrylate; CEA, cetyl acrylate; STA, stearyl acrylate; CHA, cyclohexyl acrylate; BZA, benzyl acrylate; IBXA, isobornyl acrylate; 2-MTA, 2-methoxyethyl acrylate; ETA, 2-ethoxyethyl acrylate; EETA, ethoxyethoxyethyl acrylate; PEA, 2-phenoxyethyl acrylate; THFA, tetrahydrofurfuryl acrylate; HEA, 2-hydroxyethyl acrylate; HPA, 2-hydroxypropyl acrylate; 4HBA, 4-hydroxybutyl acrylate; DMA, dimethylaminoethyl acrylate; 1,4-butylenediol diacrylate; 4EDA, tetraethylene glycol diacrylate; NDDA, 1,9-nonanediol diacrylate; 3F, trifluoroethyl acrylate; 17F, heptadecafluorodecyl acrylate; 2-PEA, 2-phenoxyethyl acrylate; TBCH, 4-tert-butylcyclohexyl acrylate; DCPA, dihydrodicyclopentadienyl acrylate; EHA, 2-ethylhexyl acrylate; 3EGMA, triethylene glycol monomethacrylate; DEGDMA, diethylene glycol dimethacrylate; PDDMA, 1,5-pentanediol dimethacrylate; BDDMA, 1,4-butanediol dimethacrylate; PRDMA, 1,3-propanediol dimethacrylate (all of the above-mentioned resins possess a viscosity <30 mPas) or from the group consisting of DDDMA, 1,10-decanediol dimethacrylate; PEG400DA, polyethylene glycol 400 diacrylate, TMPTMA, trimethylolpropane trimethacrylate, TMPTA, trimethylolpropane triacrylate; DTMPTA; di-trimethylolpropane tetraacrylate; DiPENTA, di-pentaerythritol pentaacrylate; PEG400DMA, polyethylene glycol 400 dimethacrylate, PEG300DA, polyethylene glycol 300 diacrylate, PEG300DMA, polyethylene glycol 300 dimethacrylate, BPA(EO)10DMA, ethoxylated (10) bisphenol A dimethacrylate; BPA(EO)30DMA, ethoxylated (30) bisphenol A dimethacrylate; PEG200DA, polyethylene glycol 200 diacrylate, PEG600DA, polyethylene glycol 600 diacrylate; NPG(PO)2DA propoxylated (2) neopentyl glycol diacrylate; BPA(EO)2DA, ethoxylated (4) bisphenol A diacrylate; GPTA; propoxylated glyceryl triacrylate; DMTCDDA, dimethylol tricyclo[5.2.1.0^{2,6}]decane dimethacrylate; BPA(PO)2DMA, propoxylated (2) bisphenol A dimethacrylate; DPEHA, dipentaerythritol hexaacrylate; bis-GMA, 2,2-bis[4-(2-hydroxy-3-methacryloxypropoxy)phenyl]propane; and UDMA, 1,6-bis(methacryloxy-2-ethoxycarbonylamino)-2,4,4-trimethylhexane; (all the aforementioned resins possess a viscosity >30 mPas).

Further preferred subgroups for the selection of the infiltrants are triethylene glycol dimethacrylate and trimethylolpropane trimethacrylate.

The kit of the invention may comprise application strips, cleaning strips and/or separators. The separator is an instrument with which a slight (for example about 300 μm) gap can be produced between the approximal surfaces of two adjacent teeth. Cleaning strips can be provided with an appropriate cleaning solution for preparative cleaning of dental surfaces to be treated. Application strips can be impregnated with the conditioning agent or the infiltrant and thus make it possible for these constituents of the kit to be applied simply and precisely even on the approximal surfaces, which are difficult to access, of teeth.

The suitability of various conditioning agents for eroding and demineralizing remineralized surface layers of natural enamel lesions is tested in a model system in the following exemplary embodiments and comparative examples.

These entailed investigating the etching effect on hydroxyapatite [Ca₅(PO₄)₃OH]x2 (hydroxyapatite disks) as model system for enamel, of which about 95% consists of hydroxyapatite. The etching effect of different conditioning agent or conditioner solutions can be estimated and classified therewith under reproducible conditions. The method is described in the publication by A. Klocke et al., Dental Materials 19 (2003), 773.

The hydroxyapatite disks were produced by hydraulic pressing (initial weight: 300 mg; pressure: 5000 bar; time: 35 min) of dried (2 h, 60° C.) hydroxyapatite (Riedel de Haen) with an IR press (from LOT GmbH). The disks were then embedded in a plastic (Paladur®, Heraeus Kulzer GmbH) in such a way that only one surface remained uncovered. This surface was processed with abrasive paper (500 and 1200 mesh) in order to obtain maximally reproducible surfaces, and was freed of abraded dust with compressed air. The diameter of the hydroxyapatite surface was 13 mm.

For the etching test, the hydroxyapatite disks were dipped in 4 ml of conditioner solution and shaken in a closed sample vessel on a shaker (GFL; 100 min⁻¹) for 2 min. The hydroxyapatite disks were then carefully removed from the solution with tweezers and thoroughly rinsed with water (hyperpure quality). The rinsing water was returned to the sample vessel. The contents of the sample vessel were then transferred into a 100 ml graduated flask, with the sample vessel being rinsed twice more with water, and the washing water likewise being collected in the graduated flask. The graduated flask was always made up to the 100 ml calibration mark with water. The Ca concentration in this solution was determined by atomic absorption spectroscopy (Perkin Elmer).

Table 1 below lists compositions of the invention as conditioning agents which were prepared by diluting commercially available acids in distilled water using a magnetic stirrer. Acids 1 to 4 are comparative examples, and acids 5 to 9 are examples of the invention. The last column of Table 1 indicates the calcium concentration obtained after the test described above for the respective acid.

TABLE 1

| | | pKa | | | Ca |
|---|---|---|---|---|---|
| | | (pure | Content | Conc. | conc. |
| | Acid | acid) | [%] | [mol/l] | [mg/l] |
| 1. | HCl acid | −7 | 15 | 4.12 | 20.35 |
| 2. | HEDP* | 2-3 | 60 | 2.91 | 3.7 |
| 3. | Phosphoric acid | 2.2 | 43 | 4.39 | 0.8 |
| 4. | Citric acid | 3.1 | 60 | 3.12 | 8.4 |
| 5. | Methanesulfonic | −2 | 30 | 3.12 | 38.2 |
| | acid | | | | |
| 6. | Methanesulfonic | | 50 | 5.34 | 29.9 |
| | acid | | | | |
| 7. | p-Toluenesulfonic | −2 | 50 | 2.90 | 34.1 |
| | acid | | | | |
| 8. | p-Toluenesulfonic | | 30 | 1.74 | 42.3 |
| | acid | | | | |
| 9. | Trichloroacetic | 0.08 | 50 | 3.06 | 33.3 |
| | acid | | | | |

*1-Hydroxyethane-1,1-diphosphonic acid

The table shows that the compositions of the invention show a distinctly improved etching effect even compared with 15% strength hydrochloric acid, without showing the described disadvantages of hydrochloric acid.

To check the storage stability, etching gels were produced from compositions 1, 5 and 8. For this purpose, the solutions were thickened by adding 5% by weight pyrogenic silica (Aerosil® 200, Degussa) and 0.5% by weight sorbitol-based polyetherpolyol with a hydroxyl value of 500. Mixing takes place in a Speedmixer (DAC 150 FV, from Hauschild). These gelatinous conditioning agents were stored in conventional dental application syringes for gels (Etching Gel, DMG) and embedded at 60° C. for seven days.

The storage stability was determined by measuring the acid concentration before and after storage. The results are listed in Table 2 below.

| | Vapor | | | |
|---|---|---|---|---|
| | pressure | Content | Conc. | Conc. |
| Acid | [mbar] | [%] | before | after |
| HCl acid | 127 | 15 | 15.4% | 14.1% |
| | | | by | by |
| | | | weight | weight |
| Methanesulfonic | <1 | 30 | acid | acid |
| acid | | | value | value |
| | | | 168.6 | 169.8 |
| p-Toluenesulfonic | 0.1 | 30 | acid | acid |
| acid | | | value | value |
| | | | 84.6 | 85.5 |

It is evident that the acid concentration of the hydrochloric acid gel has decreased through escape of HCl gas, while the concentration of the other, scarcely volatile acids has increased slightly through evaporation of a small part of the water used as solvent.

The acids used in the exemplary embodiments do not, under the conditions of use, form insoluble calcium salts. This is generally a preferred feature of the invention.

1. A composition which comprises:
a) 4 to 80% by weight of at least one acid which has a pKa of 2 or less;
b) a protic solvent;
the acid having a saturation vapor pressure at 20° C. of 120 mbar or less, for use as conditioning agent for etching enamel lesions.

2. The composition as claimed in claim 1, wherein the acid content is from 11 to 80% by weight, preferably 15 to 80% by weight, more preferably 20 to 70% by weight, more preferably 25 to 60% by weight.

3. The composition as claimed in claim 1 or 2, wherein the pKa of the acid is from −6 to 1, preferably −5 to 1, more preferably −4 to 1.

4. The composition as claimed in any of claims 1 to 3, wherein the protic solvent is selected from the group consisting of water and alcohols.

5. The composition as claimed in any of claims 1 to 4, wherein the partial vapor pressure of the acid in the composition at 20° C. is 80 mbar or less, preferably 50 mbar or less, more preferably 20 mbar or less, more preferably 10 mbar or less.

6. The composition as claimed in any of claims 1 to 5, which additionally comprises thickeners.

7. The composition as claimed in claim 6, wherein the thickeners are selected from the group consisting of particulate fillers and polyethers.

8. A kit for carrying out an infiltration of dental enamel, with the constituents:
a) a conditioner which has a composition as claimed in any of claims 1 to 7;
b) an infiltrant.

9. The kit as claimed in claim 8, wherein the infiltrant has a penetration coefficient PC of >50 cm/s.

10. The kit as claimed in claim 9, wherein the infiltrant comprises at least one resin selected from the group consisting of MMA, methyl methacrylate; EMA, ethyl methacrylate; n-BMA, n-butyl methacrylate; IBMA, isobutyl methacrylate, t-BMA, tert-butyl methacrylate; EHMA, 2-ethylhexyl methacrylate; LMA, lauryl methacrylate; TDMA, tridecyl methacrylate; SMA, stearyl methacrylate; CHMA, cyclohexyl methacrylate; BZMA, benzyl methacrylate; IBXMA, isobornyl methacrylate; MAA, methacrylic acid; HEMA, 2-hydroxyethyl methacrylate; HPMA, 2-hydroxypropyl methacrylate; DMMA, dimethylaminoethyl methacrylate; DEMA, diethylaminoethyl methacrylate; GMA, glycidyl methacrylate; THFMA, tetrahydrofurfuryl methacrylate; AMA, allyl methacrylate; EGDMA, ethylene glycol dimethacrylate; 3EGDMA, triethylene glycol dimethacrylate; 4EGDMA, tetraethylene glycol dimethacrylate; BDMA, 1,3-butylene glycol dimethacrylate; HDDMA, 1,6-hexanediol dimethacrylate; ETMA, ethoxyethyl methacrylate; 3FM, trifluoroethyl methacrylate; 8FM, octafluoropentyl methacrylate; AIB, isobutyl acrylate; TBA, tert-butyl acrylate; LA, lauryl acrylate; CEA, cetyl acrylate; STA, stearyl acrylate; CHA, cyclohexyl acrylate; BZA, benzyl acrylate; IBXA, isobornyl acrylate; 2-MTA, 2-methoxyethyl acrylate; ETA, 2-ethoxyethyl acrylate; EETA, ethoxyethoxyethyl acrylate; PEA, 2-phenoxyethyl acrylate; THFA, tetrahydrofurfuryl acrylate; HEA, 2-hydroxyethyl acrylate; HPA, 2-hydroxypropyl acrylate; 4HBA, 4-hydroxybutyl acrylate; DMA, dimethylaminoethyl acrylate; 1,4-butylenediol diacrylate; 4EDA, tetraethylene glycol diacrylate; NDDA, 1,9-nonanediol diacrylate; 3F, trifluoroethyl acrylate; 17F, heptadecafluorodecyl acrylate; 2-PEA, 2-phenoxyethyl acrylate; TBCH, 4-tert-butylcyclohexyl acrylate; DCPA, dihydrodicyclopentadienyl acrylate; EHA, 2-ethylhexyl acrylate; 3EGMA, triethylene glycol monomethacrylate; DEGDMA, diethylene glycol dimethacrylate; PDDMA, 1,5-pentanediol dimethacrylate; BDDMA, 1,4-butanediol dimethacrylate; PRDMA, 1,3-propanediol dimethacrylate; DDDMA, 1,10-decanediol dimethacrylate; PEG400DA, polyethylene glycol 400 diacrylate, TMPTMA, trimethylolpropane trimethacrylate, TMPTA, trimethylolpropane triacrylate; DTMPTA; di-trimethylolpropane tetraacrylate; DiPENTA, di-pentaerythritol pentaacrylate; PEG400DMA, polyethylene glycol 400 dimethacrylate, PEG300DA, polyethylene glycol 300 diacrylate, PEG300DMA, polyethylene glycol 300 dimethacrylate, BPA(EO)10DMA, ethoxylated (10) bisphenol A dimethacrylate; BPA(EO)30DMA, ethoxylated (30) bisphenol A dimethacrylate; PEG200DA, polyethylene glycol 200 diacrylate, PEG600DA, polyethylene glycol 600 diacrylate; NPG(PO)2DA propoxylated (2) neopentyl glycol diacrylate; BPA(EO)2DA, ethoxylated (4) bisphenol A diacrylate; GPTA; propoxylated glyceryl triacrylate; DMTCDDA, dimethylol tricyclo[5.2.1.0^{2,6}]decane dimethacrylate; BPA(PO)2DMA, propoxylated (2) bisphenol A dimethacrylate; DPEHA, dipentaerythritol hexaacrylate; bis-GMA, 2,2-bis[4-(2-hydroxy-3-methacryloxypropoxy)phenyl]propane; and UDMA, 1,6-bis(methacryloxy-2-ethoxycarbonylamino)-2,4,4-trimethylhexane.

11. The kit as claimed in either of claims 9 and 10, wherein the infiltrant comprises at least one resin selected from the group consisting of TEGDMA, triethylene glycol dimethacrylate; and TMPTMA, trimethylolpropane trimethacrylate.

12. The kit as claimed in any of claims 9 to 11, which comprises at least one application strip and/or cleaning strip and/or a separator.

13. The kit as claimed in claim 12, which comprises an application strip provided with a conditioner.

14. The kit as claimed in claim 12 or 13, which comprises an application strip provided with an infiltrant.
